(19) United States
(12) Patent Application Publication
(10) Pub. No.: US 2023/0296911 A1
(43) Pub. Date: Sep. 21, 2023

(54) NONLINEAR POLARIZATION FILTERING METHOD, DEVICE, AND APPLICATION APPARATUS

(71) Applicants: Chongqing Institute of East China Normal University, Chongqing (CN); ROI Optoelectronics Technology CO, LTD., Shanghai (CN); Yunnan Huapu quantum Material Co., Ltd, Kunming (CN); GuangDong ROI Optoelectronics Technology Co., Ltd., Dongguan (CN); East China Normal University, Shanghai (CN); Chongqing Huapu Intelligent Equipment Co., Ltd., Chongqing (CN); Chongqing Huapu Quantum Technology Co., Ltd., Chongqing (CN)

(72) Inventors: Heping ZENG, Chongqing (CN); Zhengru GUO, Chongqing (CN); Tingting LIU, Chongqing (CN)

(21) Appl. No.: 18/182,745

(22) Filed: Mar. 13, 2023

(30) Foreign Application Priority Data
Mar. 15, 2022 (CN) 202210255648.8

(51) Int. Cl. G02B 27/28; H01S 3/10; G02F 1/39

(52) U.S. Cl. CPC G02B 27/288; H01S 3/10061; G02F 1/397

(57) ABSTRACT

Provided are a nonlinear polarization filtering method, device, and apparatus. The device comprises a pump source, a coupler, a birefringent medium, and several polarizers; wherein the pump source is applied to output a pump laser, so as to make a photo-induced birefringence effect occur at the birefringent medium; the polarizer is applied to polarize a signal light according to a preset polarizing angle; and the coupler is applied to couple the pump laser and the signal light into the birefringent medium, wherein an angle except 0° exists between the birefringent medium and the preset polarizing angle of the polarizer.

### CROSS-REFERENCE TO RELATED APPLICATION

The application claims priority to Chinese Patent Application No. 202210255648.8, filed on Mar. 15, 2022, the entire disclosure of which is incorporated herein by reference.

### FIELD

The present disclosure relates to the technical field of optical signal processing, in specific to a nonlinear polarization filtering method, device, and application apparatus.

### BACKGROUND

Optical filter is one of the most common optical elements, and its wavelength dependence makes it of vital importance in the aspect of optical signal processing. A common optical filter is usually a filter in the form of mirror, represented by an absorption or interference optical filter. However, these spatial filters usually have the problem of that a single operating wavelength and passband width (bandwidth) are difficult to be tuned.

Lyot filter is a periodic filter device that depends on a linear birefringent effect of crystal, generally including a birefringent crystal sandwiched in two polarizers. Although the Lyot filter has solved some problems of tuning problem of the traditional filter. However, the tuning range is limited to the separation of neighboring two wavelength peaks. To change the tuning range, the birefringent crystal has to be replaced, which is equivalent to replacing the filter directly.

Therefore, it is of significance to provide a new filter device that can be accurately and continuously tuned, and the center wavelength and passband width (bandwidth) of that can be changed, for realizing high-precision optical signal processing. In addition, relevant applications of such a filter, especially in ultra-fast lasers, will greatly promote the realization and development of broadband tunable laser pulse oscillators.

### SUMMARY

A first objective of the present disclosure is to provide a nonlinear polarization filter device that realizes accurate and continuous tuning and change for the passband width and central wavelength of the filter.

To solve the above technical problems, the present disclosure provides the following technical solutions.

Provided is a nonlinear polarization filter device, including a pump source, a coupler, a birefringent medium, and several polarizers; wherein the pump source is applied to output a pump laser, so as to make a photo-induced birefringence effect occur at the birefringent medium; the polarizer is applied to polarize a signal light according to a preset polarizing angle; and the coupler is applied to couple the pump laser and the signal light into the birefringent medium, wherein an angle except 0° exists between the birefringent medium and the preset polarizing angle of the polarizer.

The principle and beneficial effects of the basic solutions of the present disclosure are as follows.

In the relevant art, optical filter is a common filtering device, which alternately forms a metal-medium-metal film or an all-medium film with a certain thickness having a high or low refractive index, relying on the vacuum coating method on the surface of the medium, to form a low-order, multi-stage series solid Fabry-Perot interferometer. Selections of the material, thickness and series connection mode of the film determine the central wavelength and transmission bandwidth λ at which the filter works, and that process is complex, expensive and time-consuming. However, in the present embodiments, the signal light is polarized by the polarizer, the pump laser is output by controlling the pump source, and then the pump laser and the signal light are coupled into the birefringent medium by the coupler, where the pump laser will cause the birefringent medium to produce photo-induced birefringent effect (nonlinear birefringence), and the nonlinear birefringence will offset or superimpose the linear birefringence, so as to realize the continuous tuning and adjusting for the overall birefringence of the birefringent medium, thereby achieving the purpose of changing the passband width and center wavelength.

In some embodiments, the number of the polarizers is two, the two polarizers, the coupler and the birefringent media are arranged on a same optical path, and the two polarizers are respectively located at both ends of the optical path; and the polarizing angles of the two polarizers are consistent.

The nonlinear polarization filter device in some embodiments possesses a single-pass structure. After passing through one polarizer, the signal light is polarized according to the preset polarizing angle, the pump source outputs the pump laser, the coupler couples the pump laser and the signal light into the birefringent medium, the birefringent medium produces the photo-induced birefringence effect, and the signal light transmitted through the birefringent medium is output after passing through the other polarizer.

According to the structure of FIG. 1, an incident light (i.e. signal light), light field and optical components may be characterized by a Jones matrix. It is assumed that the Jones matrix of the incident light is

$$\vec{{E}_{I}} = ( \begin{matrix}1 \\ 0\end{matrix} ) ,$$

the Jones matrix or two polaroids (i.e. a specific form of the polarizer) is

$$\vec{{J}_{pol .}} = ( \begin{matrix}1 \\ 0\end{matrix} ) ,$$

the Jones matrix of intermediate birefringent medium (i.e. birefringent fiber) is

$$\vec{{J}_{med .}} = ( \begin{matrix}{e}^{i φ} & 0 \\ 0 & {e}^{- i φ}\end{matrix} ) ,$$

where, φ=πBL/λ, in which B represents a birefringence coefficient of the birefringent medium, including a linear birefringence coefficient and a nonlinear birefringence coefficient (B=Bₗ+Bₙₗ). L represents the length of the birefringent medium, and λ is the wavelength of the incident light. In addition, due to the existence of an angle θ between the birefringent medium and the polarizing angle of the incident light, the matrix is further considered to be rotated, i.e.

$$\vec{{J}_{r o t . ( θ )}} = ( \begin{matrix}cos θ & - sin θ \\ sin θ & cos θ\end{matrix} ) .$$

Then, after the incident light passes through the filtering device according to the embodiments of the present disclosure, the Jones matrix of the output light is:

\vec{E_{O}}=\vec{J_{rot.(θ)}}·\vec{J_{med.}}·\vec{J_{rot.(-θ)}}·\vec{E_{I}},

and the transmission curve expression of the filtering device in embodiments of the disclosure is:

$$T = \frac{\vert {{E}^{⟶}}_{O}^{2} \vert}{\vert {{E}^{⟶}}_{I}^{2} \vert} = 1 - {cos}^{2} ( 2 θ ) {sin}^{2} ( π BL / λ ) .$$

Typical characteristics of this transmission function are shown in FIG. 2. Apparently, the transmission function of the nonlinear polarization filter device in embodiments of the present disclosure is periodically modulated with the wavelength. The nonlinear polarization filter device presents the effect of multi-passband filtering for the incident light, where the passband period is Δλ=λ²/BL, and the modulation depth of the nonlinear polarization filter device is related to the angle θ. Therefore, the passband width of the nonlinear polarization filter device can be changed by adjusting the birefringence coefficient B of the birefringent medium and its length L.

For a given birefringent medium B, B=Bₗ+Bₙₗ, where the linear birefringence coefficient Bₗ is a fixed value, and the nonlinear birefringence coefficient Bₙₗ is related to the incident light intensity. For a birefringent medium, its birefringence coefficient B=nₒ−nₑ, where nₒ and nₑ correspond to refractive index coefficients of the optical axes of the ordinary o light and the extraordinary e light respectively (for an optical fiber medium, that correspond to the fast and slow axes of the optical fiber respectively). For the birefringent medium:

nₒ=nₒₗ+Δnₒ

nₑ=nₑₗ+Δnₑ,

where, nₒₗ and nₑₗ are inherent linear refractive indexes of different optical axes of the birefringent medium, and Δnₒ and Δnₑ are the nonlinear birefringence coefficients caused by a pump light intensity,

Δnₒ=2n₂|E_{P}|²

Δnₑ=2n₂b|E_{P}|².

|Eₚ|² is the pump light intensity, n₂ is the nonlinear refractive index coefficient of the birefringent medium. Generally, the value of b is ⅓, and thus the nonlinear birefringence coefficient introduced by the pump light intensity is:

$${B}_{nl} = Δ {n}_{o} - Δ {n}_{e} = \frac{4}{3} {n}_{2} {\vert {E}_{P} \vert}^{2} ,$$

in which n₂ represents the nonlinear refractive index coefficient of the birefringent medium. Take quartz optical fiber medium as an example, the value of n₂ is in the range of (2.2-3.4)×10-20 m²/w. For the optical fiber, its linear birefringence coefficient Bₗ is in the range of (10⁻⁶-10⁻⁴). If the pump light intensity reaches at the level of 10¹⁶-10¹⁴ w/m², the resulting nonlinear birefringence coefficient will be equivalent to the linear birefringence coefficient and cannot be ignored.

For ultrashort pulse transmitted in optical fiber medium (pulse width of picosecond or even femtosecond), when the peak power reaches at a level of 10 kW, the pump light intensity can reach 10¹⁴ w/m². By adjusting the incident pump light intensity, the overall birefringence coefficient of the nonlinear polarization filter device in embodiments of the disclosure can be adjusted. Further, by adjusting the pump light intensity, the passband width and center position of the filter are continuously changed thereby realizing adjustments to the output laser spectral bandwidth and center wavelength.

In some embodiments, the nonlinear polarization filter device further includes a first reflector, and the number of the polarizers is one, the polarizer, the coupler, the birefringent medium and the first reflector are arranged on the same optical path,

where the first reflector is applied to return the signal light output by the birefringent medium back by retracing an original path.

The nonlinear polarization filter device in some embodiments is a round-trip structure. After passing through the polarizer, the signal light is polarized according to the preset polarizing angle. The pump source outputs the pump laser. The coupler couples the pump laser and the signal light into the birefringent medium. The birefringent medium produces the photo-induced birefringence effect. The signal light output by the birefringent medium is reflected back by the first reflector and then passes through the birefringent medium, coupler and polarizer again, realizing the return through the original path.

Further, the angle between the birefringent medium and the preset polarizing angle of the polarizer is less than or equal to 45°.

The angle influences the modulation depth of the nonlinear polarization filter device. When the angle is 45°, the modulation depth is maximum, and there is no modulation when the angle is 0° . The modulation depth may be adjusted in real time by changing the angle.

Further, the polarizer is a polaroid, an isolator, a polarization beam splitter, or a single-axis operating unit coupled by an optical fiber, the polarized signal light is a linearly polarized light;

the birefringent medium is a passive birefringent crystal, an active birefringent crystal, an active birefringent fiber or a passive birefringent fiber;

the pump source is a continuous laser light source or a pulse laser light source, and the pump source is applied to output the pump laser once or in real time; and

the coupler is a spatial beam splitter, an optical fiber wavelength division multiplexer, an optical fiber coupler or a beam combiner.

When the nonlinear polarization filter device of the embodiments is utilized, the pump light intensity is changed in real time so that the output filtering effect is changed immediately, thereby realizing an adjustable filtering effect in real time.

Further, the pump source is applied to output the pump laser, and an ordinary light optical axis and an extraordinary light optical axis of the birefringent medium are nondifferentiated pumped so that the ordinary light optical axis and the extraordinary light optical axis present unbalanced nonlinear birefringence changes; or the ordinary light optical axis and the extraordinary light optical axis of the birefringent medium are differentially pumped to trigger the nonlinear birefringence changes based on the imbalance of gain coefficients of the ordinary light optical axis and the extraordinary light optical axis.

The imbalanced nonlinear birefringence changes obtained by the ordinary light optical axis and the extraordinary light optical axis may introduce the nonlinear birefringence coefficient varying with the light intensity, to further change the passband width of the nonlinear polarization filter device in embodiments of the disclosure.

A second objective of the present disclosure is to provide a nonlinear polarization filtering method, including the following steps:

S1, outputting a pump laser;

S2, polarizing a signal light according to a preset polarizing angle, where an angle except 0° exists between a birefringent medium and the preset polarizing angle;

S3, coupling the pump laser and the signal light into the birefringent medium; and

S4, polarizing the signal light output by the birefringent medium again according to the preset polarizing angle and outputting the signal light; or returning the signal light output by the birefringent medium back by retracing an original path.

In embodiments of the present disclosure, the nonlinear birefringence is used to offset or superimpose the linear birefringence, so as to realize the continuous tuning and adjusting for the overall birefringence of the birefringent medium. By introducing the nonlinear polarization filter device of embodiments of the present disclosure to a laser, a broadband tunable laser pulse oscillator may be further realized.

Further, the step S1 further includes adjusting an intensity of the pump laser according to setting requirements of the passband width and the center position; and

the step S2 further includes adjusting the angle between the birefringent medium and the preset polarizing angle according to a setting requirement of the modulation depth, wherein the angle between the birefringent medium and the preset polarizing angle of the polarizer is less than or equal to 45°.

The passband width Δλ=λ²/BL. Therefore, the passband width and center position may be changed by adjusting the length L and the birefringence coefficient B of the birefringence medium. However, adjusting the length L of the birefringent medium means that the original birefringent medium needs to be replaced, which costs too much. For a given birefringent medium, its birefringence coefficient B=Bₗ+Bₙₗ, where Bₗ is the inherent linear birefringence coefficient of the medium, and Bₙₗ is the nonlinear photo-induced birefringence coefficient caused by the pump light intensity. Based on

$${B}_{nl} = Δ {n}_{o} - Δ {n}_{e} = \frac{4}{3} {n}_{2} {\vert {E}_{P} \vert}^{2} ,$$

where n₂ is the nonlinear refractive index coefficient of the medium, and |E_{P}|² is the pump light intensity, it can be seen that adjustment of the intensity of the incident pump laser can change the birefringence coefficient of the medium, and further change the passband width and the center position of the filter.

When the angle is 45°, the modulation depth is maximum, and there is no modulation when the angle is 0°. The modulation depth may be adjusted in real time by changing the angle.

A third objective of the present disclosure is to provide a nonlinear polarization filtering application apparatus, where the apparatus is provided with a nonlinear polarization filter device according to above embodiments, and further includes an input coupler, a gain medium, a saturable absorber, an isolator, a first output coupler, and a pump laser source, where

the pump laser source is applied to output a pump laser, so as to make a photo-induced birefringence effect occur at the gain medium;

the input coupler is applied to couple the pump laser and the laser into the gain medium; and

the gain medium is applied to input a passed laser into the nonlinear polarization filter device,

where a laser output by the nonlinear polarization filter device passes through the saturable absorber and the isolator and is output by the first output coupler outward.

The nonlinear polarization filter device may also be applied to a laser oscillator with linear cavity structure, which can greatly improve the flexibility, controllability and tunability of the output parameters of the laser oscillator.

Provided is a nonlinear polarization filtering application apparatus, where the apparatus is provided with a nonlinear polarization filter device according to above embodiments, and further includes a second reflector, an input coupler, a gain medium, a saturable absorber, a second output coupler, and a pump laser source, where

the pump laser source is applied to output a pump laser, so as to make a photo-induced birefringence effect occur at the gain medium;

the input coupler is applied to couple the pump laser and the laser into the gain medium;

the gain medium is applied to input a passed laser into the nonlinear polarization filter device,

where a laser output by the nonlinear polarization filter device passes through the saturable absorber and is input into the second output coupler;

the second output coupler is applied to reverse the laser; the reversed laser passes through the saturable absorber and is input into the nonlinear polarization filter device, the gain medium, the input coupler, and then input to the second reflector;

the second reflector is applied to reverse the laser again to return the laser back by retracing an original path; and

the second output coupler is further applied to output the returned laser outward.

### BRIEF DESCRIPTION OF THE DRAWINGS

FIG. 1 shows a schematic diagram of a typical nonlinear polarization filter device;

FIG. 2 shows a transmission curve of a typical nonlinear polarization filter device;

FIG. 3 shows a schematic diagram of a nonlinear polarization filter device with a single-pass structure in Example 1;

FIG. 4 shows the relationship between the transmission curve and the wavelength of a pump laser in Example 1;

FIG. 5 shows a schematic diagram of a nonlinear polarization filter device with a round-trip structure in Example 2;

FIG. 6 shows the relationship between the transmission curve and the wavelength of a pump laser in Example 2;

FIG. 7 shows a block diagram of a ring cavity ultrafast laser pulse oscillator in Example 4; and

FIG. 8 shows a block diagram of a linear cavity ultrafast laser pulse oscillator in Example 5.

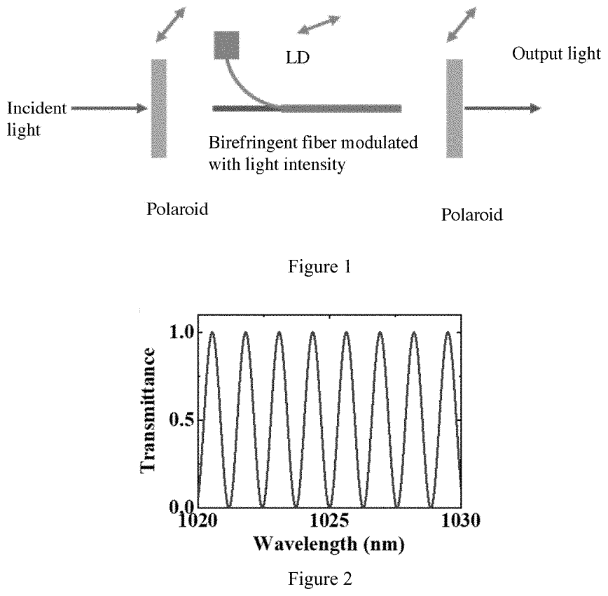

### DETAILED DESCRIPTION

Reference will now be made in detail to embodiments, examples of which are illustrated in the accompanying drawings.

References in the drawings include: a first polarizer 1, an active birefringent crystal 2, a second polarizer 3, a pump source 4, a dichroic mirror 5, an angle fusion joint 6, a single-axis operating coupler 7, a wavelength division multiplexer 8, an active birefringent fiber 9, and an optical fiber reflector 10.

### Example 1

As shown in FIG. 3, a nonlinear polarization filter device in the Example includes a first polarizer 1, a birefringent medium, a second polarizer 3, a pump source 4 and a coupler. In this Example, the coupler being used is a spatial beam splitter, specifically is a dichroic mirror 5.

The first polarizer 1, the dichroic mirror 5, the birefringent medium and the second polarizer 3 are arranged on the same optical path sequentially.

The first polarizer 1 is a polaroid, and the angle between it and the incident signal light is adjusted to make the polarized signal light be a linearly polarized light, in specific, ensuring that only the signal light with vertical linear polarization can pass through. The second polarizer 3 is also a polaroid, which is placed at the same angle and with the same parameters as the first polarizer 1.

In this Example, the birefringent medium is an active birefringent crystal 2, specifically is a neodymium-doped yttrium vanadate crystal, which is a typical active birefringent crystal. The active birefringent crystal 2 is placed to make its o optical axis form an angle of 45° with the vertical direction, and its birefringence coefficient is at the level of 10⁻⁴. In addition, because the yttrium vanadate crystal is doped with rare-earth neodymium ions, a spontaneous radiation laser at wave band of 1064 nm will be generated after being excited by the pump laser. In other examples, passive birefringent crystals may also be used.

The pump source 4 is preferably a laser diode (LD) with spatially coupled output, of which an output wavelength of the pump laser is 808 nm and an output power is up to 200 W. After the pump laser is input into the active birefringent crystal, the spontaneous radiation laser of 1064 nm will be excited and output.

The dichroic mirror 5 is a coated mirror with a high reflection of 808 and an antireflection of 1064. The dichroic mirror 5 is placed as shown in FIG. 3, and is used to couple the pump laser of 808 nm and the signal light of 1064 nm into the active birefringent crystal.

After the pump laser output by the pump source 4 enters the active birefringent crystal, the pump laser causes its prominent nonlinear birefringence coefficient, which will offset or superimpose the inherent birefringence (linear birefringence) of the active birefringent crystal. By changing the power of the incident pump laser, the continuous tuning of the overall birefringence of the active birefringent crystal can be realized, thereby achieving the accurate, continuous and real-time tuning and adjusting of the output bandwidth and the central wavelength position of the nonlinear polarization filter device.

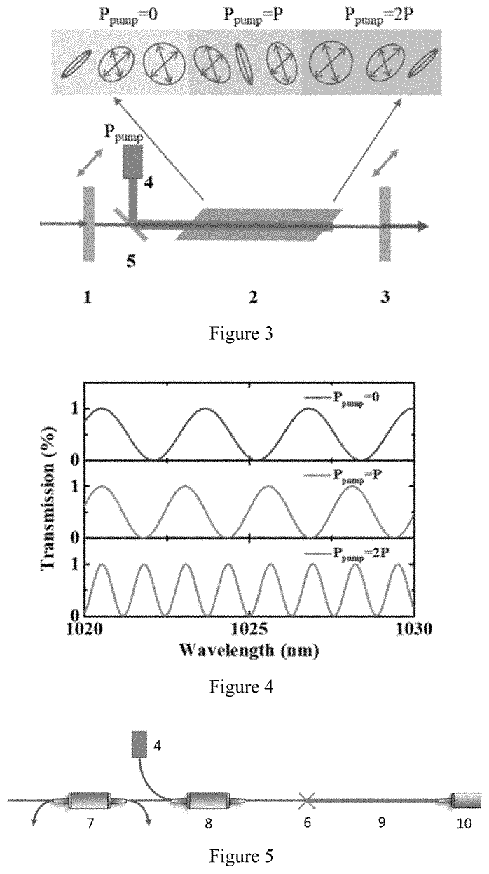

As shown in FIG. 4, when the pump laser power is 0, the passband width of the nonlinear polarization filter device in the Example is mainly determined by the length of the medium and its inherent linear birefringence, while the nonlinear birefringence does not work, where the passband width is about 3.2 nm; when the pump laser power is P=2000 W, the nonlinear birefringence coefficient caused by the strong field pump laser becomes prominent, and the passband width becomes 2.5 nm; and when the pump laser power is further increased to P=2 P, the influence of the pump laser on the nonlinear birefringence coefficient is more prominent, and the passband width becomes 1.3 nm, which proves the feasibility of the solutions of the Example.

It should be noted that the Example only takes the nonlinear polarization filter device of spatial structure as an example for illustration. All changes in its form, such as changes of the nonlinear polarization filter device of all-fiber structure, half-space and half-fiber structure, should fall within the protection scope of the present disclosure.

### Example 2

This Example provides a nonlinear polarization filter device with a round-trip all-fiber structure, including a polarizer, a pump source 4, a coupler, an angle fusion joint 6, a birefringent medium and a first reflector sequentially, in connection order.

In the Example, the polarizer is a single-axis operating component coupled by optical fiber, specifically is a single-axis operating coupler 7. In other examples, isolators or polarization beam splitters may also be used. The coupler is an optical fiber wavelength division multiplexer 8. In other examples, an optical fiber coupler or a beam combiner may also be used. The birefringent medium is an active birefringent fiber 9. The first reflector is the optical fiber reflector 10. In other examples, the birefringent medium may also be a passive birefringent fiber.

The single-axis operating coupler 7, the wavelength division multiplexer 8, the angle fusion point 6, the active birefringent fiber 9 and the optical fiber reflector 10 are connected sequentially, and the output end of the pump source 4 is connected with the input end of the wavelength division multiplexer 8, forming an optical fiber route as shown in FIG. 5.

The single-axis operating coupler 7 is preferably a 2×2 polarization-maintaining fiber coupler, with typical characteristics of slow axis working and fast axis block. When the signal light is incident into the single-axis operating coupler 7, only the signal light transmitted along the slow axis can pass through. A beam-splitting ratio of the single-axis operating coupler 7 is preferably 50:50. At this time, the nonlinear polarization filter device formed in this example has the largest modulation depth. Increasing or decreasing the beam-splitting ratio can continuously and controllably change the final modulation depth.

The pump source 4 is a fiber-coupled semiconductor LD, which outputs a continuous laser light source or pulse laser light source with different peak power (P), and its output end is connected with the wavelength division multiplexer 8.

The wavelength division multiplexer 8 is applied to couple the pump laser output by the pump source 4 and the signal light output by the single-axis operating coupler 7 into the active birefringent fiber 9.

The active birefringent fiber 9 is a special fiber whose core is doped with rare earth ions, such as ytterbium, neodymium, erbium, thulium, etc. It will generate a spontaneous radiation laser when excited by the pump laser output by the pump source 4. Unlike the birefringent crystals, the active birefringent fiber 9 has fast and slow axes, and its birefringence coefficient B includes a linear birefringence coefficient Bₗ and a nonlinear birefringence coefficient Bₙₗ, where Bₙₗ=4×10⁻⁴, and length L=0.8 m.

The angle fusion joint 6 is for ensuring that the polarization state (slow axis) of the single-axis operating coupler 7 forms a certain angle θ with the slow axis of the active birefringent fiber 9. The angle affects the modulation depth of the nonlinear polarization filter device formed in this example. When the angle is 45°, the modulation depth is maximum, and when the angle is 0°, there is no modulation. The modulation depth can be adjusted in real time by changing the fusion angle.

The optical fiber reflector 10 is a fiber-coupled mirror, which is applied to return the signal light back to the original path and to pass through the active birefringent fiber 9, the wavelength division multiplexer 8, and the single-axis operating coupler 7 again.

For the Example, the transmission function of the nonlinear polarization filter device is:

$$T = \frac{\vert {{E}^{⟶}}_{{O}_{1}}^{2} \vert}{\vert {{E}^{⟶}}_{I}^{2} \vert} = 1 - {sin}^{2} ( 2 θ ) {cos}^{2} ( 2 π BL / λ ) ,$$

where θ is an angle of optical fiber fusion at the angle fusion joint 6, and B is the birefringence coefficient of the active birefringent fiber 9, in which

B=Bₗ+Bₙₗ, and Bₗ=4×10⁻⁴, L is the length of the active birefringent fiber 9, λ which is the wavelength of the signal light, which is selected as a wave band of 1030 nm.

According to

$${B}_{nl} = Δ {n}_{o} - Δ {n}_{e} = \frac{4}{3} {n}_{2} {\vert {E}_{P} \vert}^{2} ,$$

n₂ is the nonlinear refractive index coefficient of the active birefringent fiber 9, which is 2.5×10⁻²⁰ m²/w; |E_{P}|² is the light intensity the incident pump laser transmitted in the optical fiber. |E_{P}|²=P/πr², where P is the peak power of the pump laser, and r is the fiber core radius (in this Example, r=4 μm). Assuming that P=300 kW, then |E_{P}|²≈6×10¹⁵ w/m², and at this time, Bₙₗ=2×10⁻⁴.

The transmission function T of the nonlinear polarization filter device is further simplified as:

$$T = 1 - {sin}^{2} ( 2 θ ) {cos}^{2} [ \frac{2 π ( {B}_{l} + {B}_{nl} ) L}{λ} ] .$$

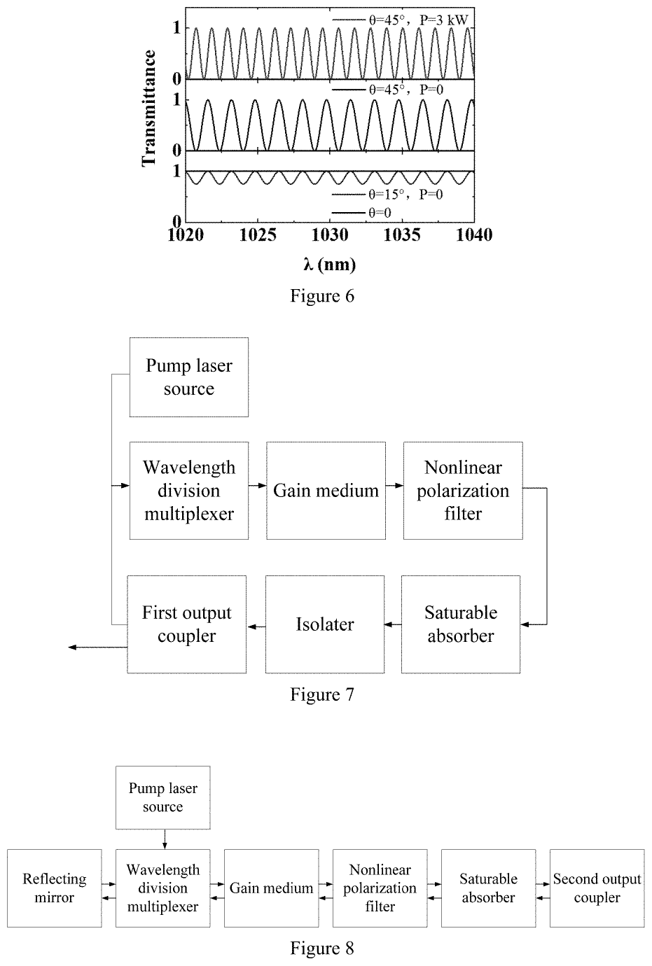

Apparently, in this Example, the transmitted light intensity and the signal light wavelength change in a cosine function curve, as shown in FIG. 6. When the optical fiber fusion angle θ at the angle fusion joint 6 is 0, the nonlinear polarization filter device in the Example has no effect on the signal light, and the incident light returns to the original path. With the increase of the angle θ, the nonlinear polarization filter device starts to work to realize a comb filtering for the signal light. The larger θ is, the greater the modulation depth of the filtering effect is. When θ is increased to 45°, the transmittance range covers 0-1, and the modulation depth reaches the maximum value. If the angle θ is increased continuously, the modulation depth will decrease. When θ is fixed at 45° and there is no incident pump laser, the comb spacing Δλ≈1.6 nm in the comb filter structure of the nonlinear polarization filter device. When the pump laser with the peak power P=3 kW is injected, Δλ changes into Δλ≈1.1 nm, proving the effect of introducing the nonlinear birefringence effect after the pumping laser injection by the nonlinear filtering device of the Examples of the present disclosure.

It should be noted that the structure and setting described in the Examples are only the conventional selection of the relevant devices of the disclosure. The optimization and change of the selection of the key devices in this example, such as replacing the ordinary optical fiber with a double-clad optical fiber or photonic crystal fiber and the like, even if these can bring advantages such as power increase, spectrum broadening, mode-locking state switching, etc., should be also fall into the scope of protection of the disclosure.

### Example 3

Based on the nonlinear polarization filter devices of Example 1 and Example 2, the Example further provides a nonlinear polarization filtering method, including the following steps: S1-S4.

At the S1, an intensity of a pump laser is adjusted according to setting requirements of a passband width and a center position, and the pump laser is output.

At the S2, an angle between a birefringent medium and a preset polarizing angle according to a setting requirement of a modulation depth, where the angle between the birefringent medium and the preset polarizing angle of a polarizer is larger than 0° but is less than or equal to 45°, and a signal light is polarized according to the preset polarizing angle.

At the S3, the pump laser and the signal light is coupled into the birefringent medium.

At the S4, the signal light output by the birefringent medium is polarized according to the preset polarizing angle and is output once again; or the signal light output by the birefringent medium is returned back by retracing an original path.

The sequence of steps in this Example is not limited. For example, in other examples, step S2 may be performed first, and then step S1 may be performed, or steps S1 and S2 may be performed at the same time.

### Example 4

This Example provides a nonlinear polarization filtering application apparatus, specifically an oscillator based on the nonlinear polarization filter device of the disclosure. The oscillator may be an all-solid-state pulse oscillator with a full-space structure, also may be a laser oscillator with an all-fiber structure or a half-space and half-fiber structure. The structure shown in this Example is only a preferred solution, instead of a limitation.

The Example provides a ring cavity ultrafast laser pulse oscillator, includes an input coupler, a gain medium, a nonlinear polarization filter, a saturable absorber, an isolator, a first output coupler, and a pump laser source. In this Example, the input coupler specifically is a wavelength division multiplexer.

Each component is set according to the relative position as shown in FIG. 7.

The wavelength division multiplexer is applied to couple the laser and the pump laser into the gain medium to realize the amplification of the laser pulse. The wavelength division multiplexer may be a dichroic mirror or an optical fiber wavelength division multiplexer, etc.

The gain medium is specifically a birefringent crystal or birefringent fiber medium doped with ytterbium, neodymium, erbium, thulium and other rare earth ions. The gain medium outputs a spontaneous radiation laser with the corresponding wavelength after being excited by the pump laser of the pump laser source.

The nonlinear polarization filter is the nonlinear polarization filter device as described in any Examples of the present disclosure.

The saturable absorber may be with a Kerr lens mode locking mechanism, or a real or artificial saturable absorption mechanism, including a semiconductor saturable absorption mirror, graphene, carbon nanotubes, nonlinear polarization rotation, nonlinear amplification ring mirror, etc.

The isolator is applied to ensure the unidirectional cycle of the laser in the entire ring cavity ultrafast laser pulse oscillator.

The first output coupler is applied to output the mode-locked pulse part generated by the ring cavity ultrafast laser pulse oscillator, thereby realizing the application.

### Example 5

The Example provides a linear cavity ultrafast laser pulse oscillator based on the nonlinear polarization filter device of the disclosure.

The pulse laser oscillator with a linear cavity structure includes a second reflector, an input coupler, a gain medium, a nonlinear polarization filter, a saturable absorber, a second output coupler and a pump laser source. In this Example, the second reflector is a reflecting mirror, and the input coupler is a wavelength division multiplexer.

Each component is set according to the relative position as shown in FIG. 8.

Some devices described in this Example have the same functions as those in Example 4, such as the wavelength division multiplexer, gain medium, nonlinear polarization filter, pump laser source, and the saturable absorber.

The reflecting mirror is applied to return the laser back to its original path and realize the laser oscillation back and forth.

The second output coupler is a semi-transparent and semi-reflective mirror, and the reflective part realizes the return of the laser to the original laser path, so as to form a two-sided cavity mirror of the linear cavity laser with the reflecting mirror, and the transparent part is applied for laser output to realize the application.

The above are only the embodiments of the present disclosure, and the present disclosure is not limited to the field related to these embodiments. The common general knowledge such as the known specific structure and characteristics of the scheme is not described in detail herein. A person of ordinary skill in the art knows all the common technical knowledge in the technical field to which the invention belongs before the application date or the priority date, will know all the existing technologies in the field, and has the ability to use the conventional experimental means before this date. A person skilled in the art can perfect and implement the solution in combination with his/her own ability under the inspiration of the present disclosure, and some typical well-known structures or well-known methods should not be an obstacle for a person skilled in the art to implement the present disclosure. It should be pointed out that for those skilled in the art, several modifications and improvements can be made without departing from the structure of the present invention, which should also be regarded as the protection scope of the present disclosure, and these will not affect the implementation effect of the present disclosure and the utility of the patent. The scope of protection required by the disclosure shall be subject to the contents of the claims, and the detailed description in the description can be used to interpret the contents of the claims.

What is claimed is:

1. A nonlinear polarization filter device, comprising a pump source, a coupler, a birefringent medium, and several polarizers; wherein the pump source is applied to output a pump laser, so as to make a photo-induced birefringence effect occur at the birefringent medium; the polarizer is applied to polarize a signal light according to a preset polarizing angle; and the coupler is applied to couple the pump laser and the signal light into the birefringent medium, wherein an angle except 0° exists between the birefringent medium and the preset polarizing angle of the polarizer,
wherein the angle between the birefringent medium and the preset polarizing angle of the polarizer is less than or equal to 45°.

2. The nonlinear polarization filter device according to claim 1, wherein the number of the polarizers is two, the two polarizers, the coupler and the birefringent medium are arranged on a same optical path, the two polarizers are respectively located at both ends of the optical path, and the polarizing angles of the two polarizers are consistent.

3. The nonlinear polarization filter device according to claim 1, further comprising a first reflector, wherein the number of the polarizers is one, the polarizer, the coupler, the birefringent medium and the first reflector are arranged on a same optical path,
wherein the first reflector is applied to return the signal light output by the birefringent medium back by retracing an original path.

4. The nonlinear polarization filter device according to claim 1, wherein the polarizer is a polaroid, an isolator, a polarization beam splitter, or a single-axis operating unit coupled by an optical fiber, the polarized signal light is a linearly polarized light;
the birefringent medium is a passive birefringent crystal, an active birefringent crystal, an active birefringent fiber or a passive birefringent fiber;
the pump source is a continuous laser light source or a pulse laser light source, and the pump source is applied to output the pump laser once or in real time; and
the coupler is a spatial beam splitter, an optical fiber wavelength division multiplexer, an optical fiber coupler or a beam combiner.

5. The nonlinear polarization filter device according to claim 4, wherein the pump source is applied to output the pump laser, and an ordinary light optical axis and an extraordinary light optical axis of the birefringent medium are nondifferentiated pumped so that the ordinary light optical axis and the extraordinary light optical axis present unbalanced nonlinear birefringence changes; or the ordinary light optical axis and the extraordinary light optical axis of the birefringent medium are differentially pumped to trigger the nonlinear birefringence changes based on the imbalance of gain coefficients of the ordinary light optical axis and the extraordinary light optical axis.

6. The nonlinear polarization filter device according to claim 1, wherein a Jones matrix of the output light passed through the nonlinear polarization filter device is:
\vec{E_{O}}=\vec{J_{rot.(θ)}}·\vec{J_{med.}}·\vec{J_{rot.(-θ)}}·\vec{E_{I}}.

7. The nonlinear polarization filter device according to claim 1, wherein a transmission curve expression of the nonlinear polarization filter device is:
$$T = \frac{\vert {{E}^{⟶}}_{O}^{2} \vert}{\vert {{E}^{⟶}}_{I}^{2} \vert} = 1 - {cos}^{2} ( 2 θ ) {sin}^{2} ( π BL / λ ) ,$$
wherein B represents a birefringence coefficient of the birefringent medium, L represents the length of the birefringent medium, λ is the wavelength of the signal light, and θ is the angle between the birefringent medium and the preset polarizing angle of the polarizer.

8. The nonlinear polarization filter device according to claim 1, wherein a nonlinear birefringence coefficient Bₙₗ introduced by the intensity of the pump laser is:
$${B}_{nl} = \frac{4}{3} {n}_{2} {\vert {E}_{P} \vert}^{2} ,$$
wherein n₂ represents a nonlinear refractive index coefficient of the birefringent medium, |Eₚ|² is the intensity of the pump laser.

9. A nonlinear polarization filtering method, comprising the following steps:
S1, outputting a pump laser;
S2, polarizing a signal light according to a preset polarizing angle, wherein an angle except 0° exists between a birefringent medium and the preset polarizing angle;
S3, coupling the pump laser and the signal light into the birefringent medium; and
S4, polarizing the signal light output by the birefringent medium again according to the preset polarizing angle and outputting the signal light; or returning the signal light output by the birefringent medium back by retracing an original path.

10. The nonlinear polarization filtering method according to claim 9, wherein the step S1 further comprises adjusting an intensity of the pump laser according to setting requirements of a passband width and a center position; and
the step S2 further comprises adjusting the angle between the birefringent medium and the preset polarizing angle according to a setting requirement of a modulation depth, wherein the angle between the birefringent medium and the preset polarizing angle of a polarizer is less than or equal to 45°.

11. The nonlinear polarization filtering method according to claim 9, wherein the pump source outputs the pump laser, and an ordinary light optical axis and an extraordinary light optical axis of the birefringent medium are nondifferentiated pumped so that the ordinary light optical axis and the extraordinary light optical axis present unbalanced nonlinear birefringence changes; or the ordinary light optical axis and the extraordinary light optical axis of the birefringent medium are differentially pumped to trigger the nonlinear birefringence changes based on the imbalance of gain coefficients of the ordinary light optical axis and the extraordinary light optical axis.

12. The nonlinear polarization filtering method according to claim 9, wherein a Jones matrix of the output light passed through the nonlinear polarization filter device is:
\vec{E_{O}}=\vec{J_{rot.(θ)}}·\vec{J_{med.}}·\vec{J_{rot.(-θ)}}·\vec{E_{I}}.

13. The nonlinear polarization filtering method according to claim 9, wherein a transmission curve expression of the nonlinear polarization filter device is:
$$T = \frac{\vert {{E}^{⟶}}_{O}^{2} \vert}{\vert {{E}^{⟶}}_{I}^{2} \vert} = 1 - {cos}^{2} ( 2 θ ) {sin}^{2} ( π BL / λ ) ,$$
wherein B represents a birefringence coefficient of the birefringent medium, L represents the length of the birefringent medium, λ is the wavelength of the signal light, and θ is the angle between the birefringent medium and the preset polarizing angle of the polarizer.

14. The nonlinear polarization filtering method according to claim 9, wherein a nonlinear birefringence coefficient Bₙₗ introduced by the intensity of the pump laser is:
$${B}_{nl} = \frac{4}{3} {n}_{2} {\vert {E}_{P} \vert}^{2} ,$$
wherein n₂ represents a nonlinear refractive index coefficient of the birefringent medium, ⊕E_{P}|² is the intensity of the pump laser.

15. A nonlinear polarization filtering application apparatus, wherein the apparatus is provided with a nonlinear polarization filter device according to claim 1, and further comprises components in set i) or ii) as follows:
set i): the apparatus further comprises an input coupler, a gain medium, a saturable absorber, an isolator, a first output coupler, and a pump laser source, wherein:
the pump laser source is applied to output a pump laser, so as to make a photo-induced birefringence effect occur at the gain medium;
the input coupler is applied to couple the pump laser and the laser into the gain medium; and
the gain medium is applied to input a passed laser into the nonlinear polarization filter device,
wherein a laser output by the nonlinear polarization filter device passes through the saturable absorber and the isolator and is output by the first output coupler outward; or
set ii): the apparatus further comprises a second reflector, an input coupler, a gain medium, a saturable absorber, a second output coupler, and a pump laser source, wherein:
the pump laser source is applied to output a pump laser, so as to make a photo-induced birefringence effect occur at the gain medium;
the input coupler is applied to couple the pump laser and the laser into the gain medium;
the gain medium is applied to input a passed laser into the nonlinear polarization filter device,
wherein a laser output by the nonlinear polarization filter device passes through the saturable absorber and is input into the second output coupler;
the second output coupler is applied to reverse the laser; the reversed laser passes through the saturable absorber and is input into the nonlinear polarization filter device, the gain medium, the input coupler, and then input to the second reflector;
the second reflector is applied to reverse the laser again to return the laser back by retracing an original path; and
the second output coupler is further applied to output the returned laser outward.
